(19) United States
(12) Patent Application Publication
(10) Pub. No.: US 2011/0026705 A1
(43) Pub. Date: Feb. 3, 2011

(54) METHOD AND SYSTEM FOR PREVENTING COPY OF PLATFORM

(75) Inventors: Hyug Rae CHO, Seoul (KR); Jong Rip LEE, Bucheon-si (KR); Sung Hwa LEE, Anyang-Si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD, Suwon-si (KR)

(21) Appl. No.: 12/650,603

(22) Filed: Dec. 31, 2009

(30) Foreign Application Priority Data
Jan. 9, 2009 (KR) 10-2009-0001941

(51) Int. Cl. H04L 9/28; G01N 21/00; G06K 7/10; G06F 17/00

(52) U.S. Cl. 380/28; 356/432; 235/462.01; 235/375

(57) ABSTRACT

A method and system for preventing copy of a platform are provided. A platform test apparatus includes a drive unit which drives a platform to cause the platform to move in a predetermined manner, at least one light source which emits light to the platform while the platform is driven so that the light is transmitted through a predetermined part of the platform, a sensor which senses the light transmitted through the platform, a calculation unit which calculates an absorption property of the platform based on a detected result of the sensor, a reading unit which reads absorption property information of the platform stored in an information storage unit of the platform, and a comparison unit which compares the absorption property calculated by the calculation unit with the absorption property information read by the reading unit to determine whether the platform is copied.

### CROSS-REFERENCE TO RELATED APPLICATION

This application claims priority from Korean Patent Application No. 2009-0001941, filed on Jan. 9, 2009 in the Korean Intellectual Property Office, the disclosure of which is incorporated herein by reference.

### BACKGROUND

1. Field

Embodiments relate to a method and system for preventing copy of a platform.

2. Description of the Related Art

A small-sized chip having a micro flow structure arranged on a chip-type substrate thereof such that tests including biochemical reaction are performed on the chip is called a biochip. In particular, a device manufactured such that several processing and handling processes are performed on a single chip is called a lab-on-a-chip. The lab-on-a-chip is a kind of biochip in which a laboratory is installed on a single chip.

Operational pressure is provided to transfer a fluid in a micro flow structure. The operational pressure may be capillary pressure or pressure generated by an additional pump. Also, centrifugal force-based micro flow devices constructed such that a micro flow structure is arranged in a compact disc type platform are used. Such a micro flow structure is referred to as a lab compact disc (CD), a lab-on-a disc, or a lab-on-a-CD.

For the lab-on-a-chip and the lab-on-a-disc, a device constituting a base on which the micro flow structure is arranged and designed is called a platform. The platform may be used for various purposes. For example, the lab-on-a-disc is a kind of platform for blood testing. Platforms are disposable such that the platforms are intended to be destroyed after use. Platforms are continuously manufactured and sold. However, the platforms have no security devices, such that the platforms may be illegally copied with ease. Also, when platforms, for which a recall has been issued due to manufacturing defects, are sold and used, test reliability is deteriorated.

### SUMMARY

One or more exemplary embodiments provide a method and system for preventing copy of a platform to improve test reliability and maximize profits of disposable platforms through the use of reliable platforms

One or more exemplary embodiments also provide a recording medium containing a program that allows a computer to perform the method, the recording medium being read by the computer.

In accordance with an aspect of an exemplary embodiment, there is provide a platform test apparatus including a drive unit which drives a platform to cause the platform to move in a predetermined manner; at least one light source which emits light to the platform while the platform is driven so that the light is transmitted through a predetermined part of the platform; a sensor which senses the light transmitted through the platform; a calculation unit which calculates an absorption property of the platform based on a detected result output by the sensor; a reading unit which reads absorption property information of the platform stored in an information storage unit of the platform; and a comparison unit which compares the absorption property calculated by the calculation unit with the absorption property information read by the reading unit to determine whether the platform is copied.

In accordance with an aspect of another examplary embodiment, there is provided a platform including a plurality of plates arranged such that the platform has a multi-layered structure, and an information storage unit which stores absorption property information of the plates based on light transmitted through the platform while the platform moves in a predetermined manner.

In accordance with an aspect of another exemplary embodiment, there is a platform test method including detecting absorption property information of a platform, reading absorption property information of the platform recorded in an information storage unit of the platform, and determining whether the platform is copied by comparing the detected information with the read information.

In accordance with a further aspect of the present invention, a computer readable recording medium contains a program that allows a computer to perform the platform test method, the recording medium being read by the computer.

### BRIEF DESCRIPTION OF THE DRAWINGS

The above and/or other aspects will become apparent and more readily appreciated from the following description of the exemplary embodiments, taken in conjunction with the accompanying drawings of which:

FIG. 1 is a view illustrating a system for preventing copy of a platform according to an embodiment;

FIG. 2 is a view illustrating a platform for blood testing according to an exemplary embodiment;

FIG. 3A is a view illustrating an information storage unit of a platform for blood testing according to an exemplary embodiment;

FIG. 3B is a view illustrating an information storage unit of a platform for blood testing according to another exemplary embodiment;

FIG. 4 is a view illustrating a system for detecting absorption property information;

FIG. 5 is a view illustrating absorbance waveforms of platforms for blood testing according to an exemplary embodiment;

FIG. 6 is a detailed view illustrating the construction of a platform test apparatus according to an exemplary embodiment shown in FIG. 1;

FIG. 7 is a view illustrating a platform test environment using revoked global unique identifier (GUID) list version information according to an exemplary embodiment;

FIGS. 8A and 8B are views illustrating a method of creating and a method of confirming an electronic signature, respectively, according to an exemplary embodiment; and

FIG. 9 is a flow chart illustrating a method of testing a platform using a platform test apparatus according to an exemplary embodiment.

### DETAILED DESCRIPTION

Reference will now be made in detail to the exemplary embodiments, examples of which are illustrated in the accompanying drawings, wherein like reference numerals refer to like elements throughout.

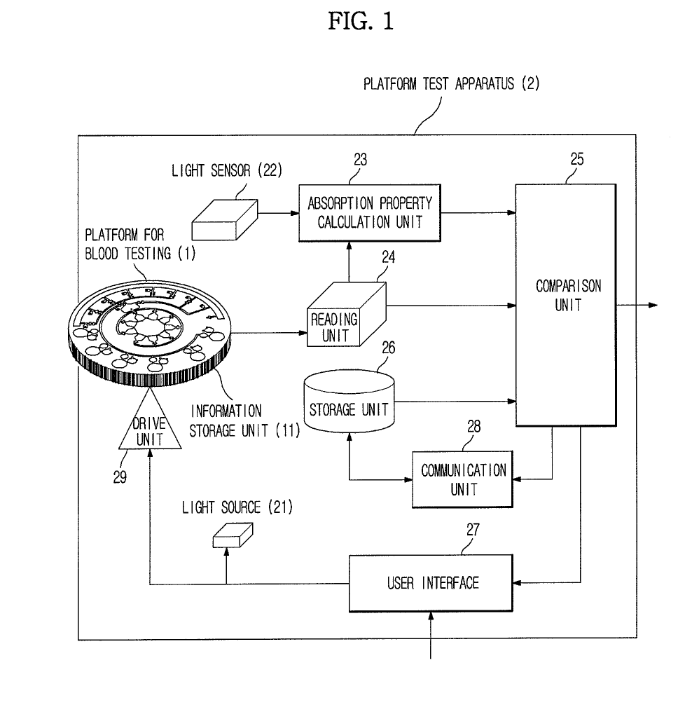

FIG. 1 is a view illustrating a system for preventing copy of a platform according to an exemplary embodiment. Referring to FIG. 1, the system includes a platform 1 and a platform test apparatus 2. As previously described, the platform 1 may be used for various purposes. In this exemplary embodiment, the platform 1 will be described as a platform for blood testing as an example for the convenience of description. An exemplary embodiment of the platform 1 may be a lab-on-a-disc. The lab-on-a-disc is constructed such that various kinds of laboratory equipment for blood diagnosis and test are integrated in a CD. The lab-on-a-disc may be coupled to a blood tester to perform a biochemical test, an immunoserological test, and a genetic test. The blood tester controls a fluid, such as blood or a reagent, provided to the lab-on-a-disc using centrifugal force to perform a biochemical test, an immunoserological test, a genetic test, a test for a hereditary disease, and a test for germs and viruses. The platform test apparatus 2 tests whether the platform 1 is copied or defective. Hereinafter, the blood tester and the platform 1 will be described as being separately provided. However, it will be appreciated by those skilled in the art that the blood tester and the platform 1 may be integrated as one body. For example, the blood tester may have a platform test function. Hereinafter, the platform 1 and the platform test apparatus 2 will be described as an exemplary embodiment for the convenience of description. However, it will be appreciated by those skilled in the art that a general platform and a general platform test apparatus may be applied to an exemplary embodiment.

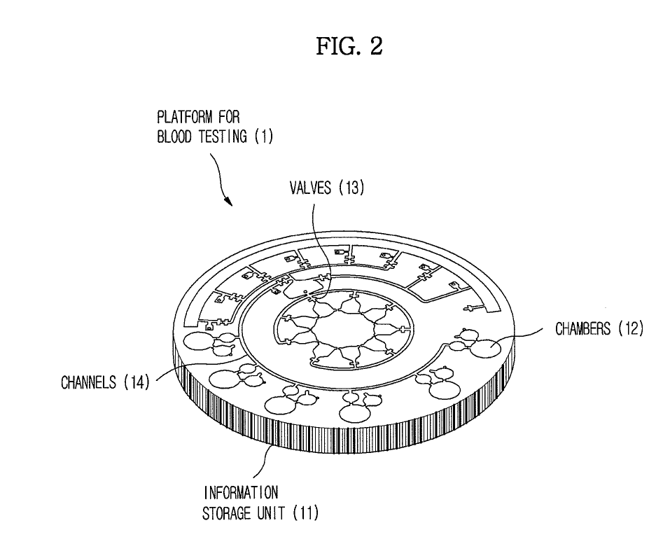

FIG. 2 is a view illustrating a platform 1 for blood testing according to an exemplary embodiment. Referring to FIG. 2, the platform 1 is a disc-type platform. The platform 1 includes an information storage unit 11 to store platform-related information and platform security-related information, one or more chambers 12 to contain a small amount of a fluid, one or more valved 13 to control flow of the fluid, and one or more channels 14 through which the fluid flows. In FIG. 2, only components of the platform 1 related to this exemplary embodiment are shown to avoid complexity. However, it will be appreciated by those skilled in the art that other components of the platform 1 may be included. Also, FIG. 2 illustrates an exemplary embodiment of the platform 1. However, it will be appreciated by those skilled in the art that other types of platforms for blood testing including the above components may be provided.

More specifically, the platform 1 is constructed such that a bio-material microarray chip is mounted in a disc-type platform made of optically transparent plastic. Also, the platform 1 includes one or more chambers 12, channels 14 to interconnect the chambers 12, and valves 13 to control flow of a fluid through the channels. The disc-type platform may be rotated. The shape of the platform is not limited to a disc. For example, a fan-shaped platform may be rotatably mounted in a rotary frame. The platform may be made of plastic, such as polymethylmethacrylate (PMMA), polydimethylsiloxane (PDMS), and poly carbonate (PC), which is easy to mold and has a biologically inactive surface. However, the material of the platform is not limited thereto. For example, materials exhibiting chemical and biological stability, optical transparency, and mechanical processability may be used. Also, the platform may be constructed such that several plates are stacked. Engraved structures, such as the chambers 12 or the channels 14, are formed at opposite sides of neighboring plates, and the plates are joined to each other to provide a space and a passageway in the platform. The plates may be joined by bonding using a bonding agent or adhesive tape or by fusing using ultrasonic waves.

Also, the information storage unit 11 may be directly printed on the surface of the platform, attached to the outside of the platform in the form of a different medium (for example, paper) having information recorded thereto, or mounted in the platform in the form of a chip.

The platform 1 is constructed such that a micro flow structure including the chambers 12, the channels 14 to interconnect the chambers, and the valves 13 to control flow of a fluid through the channels 14 are provided in the disc-type platform. Several micro flow structures may be repetitively arranged in one platform. Also, the disc-type platform has a bio-material microarray chip, to the surface of which are bound a plurality of biomaterial probes contacting a sample passing through a portion of the micro flow structure.

The information storage unit 11 stores information related to uses of the platform 1 and copy prevention information. The platform test apparatus 2 detects the copy prevention information stored in the information storage unit 11 to test whether the platform 1 is copied or defective. Also, a general blood tester detects the information related to uses of the platform 1 stored in the information storage unit 11 to perform a biochemical test, an immunoserological test, a genetic test, a test for a hereditary disease, and a test for germs and viruses using the platform 1.

A blood test method using the platform 1 will be described. The blood tester detects information stored in the information storage unit 11 of the platform 1, performs reaction between a sample (for example, for cholesterol test and liver function test) and blood in the chambers 12 according to uses of the platform, and reports the reaction results to a user.

More specifically, the blood tester separates blood into serum and blood corpuscles using centrifugal force, allows a fluid to flow along one of the channels 14, and applies heat using a laser at a predetermined point in time to open the valves 13 such that the fluid flows through the other channels 14. The blood tester detects the information related to uses of the platform 1 stored in the information storage unit 11, adjusts a path of the fluid to measure and analyze concentration and absorbance of a material obtained by mixing the fluid and a sample in the chamber 12, and reports the test results to a user.

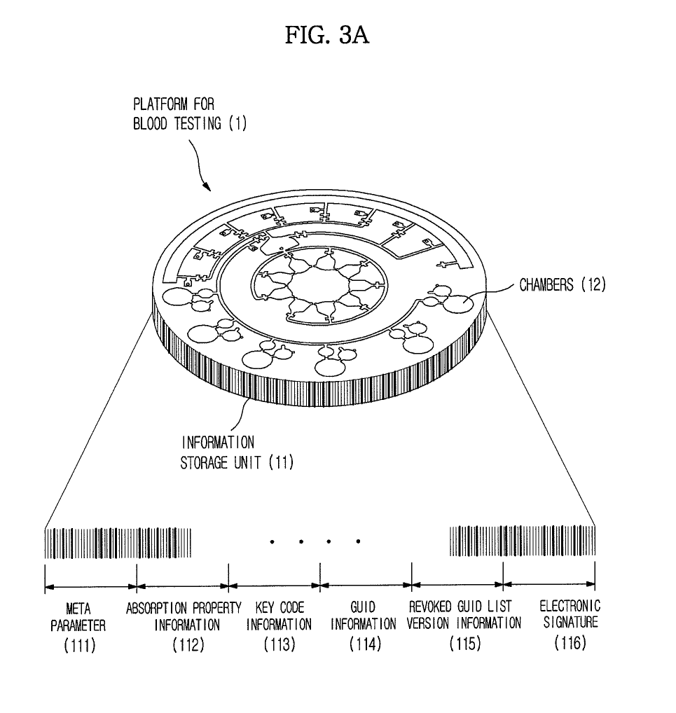

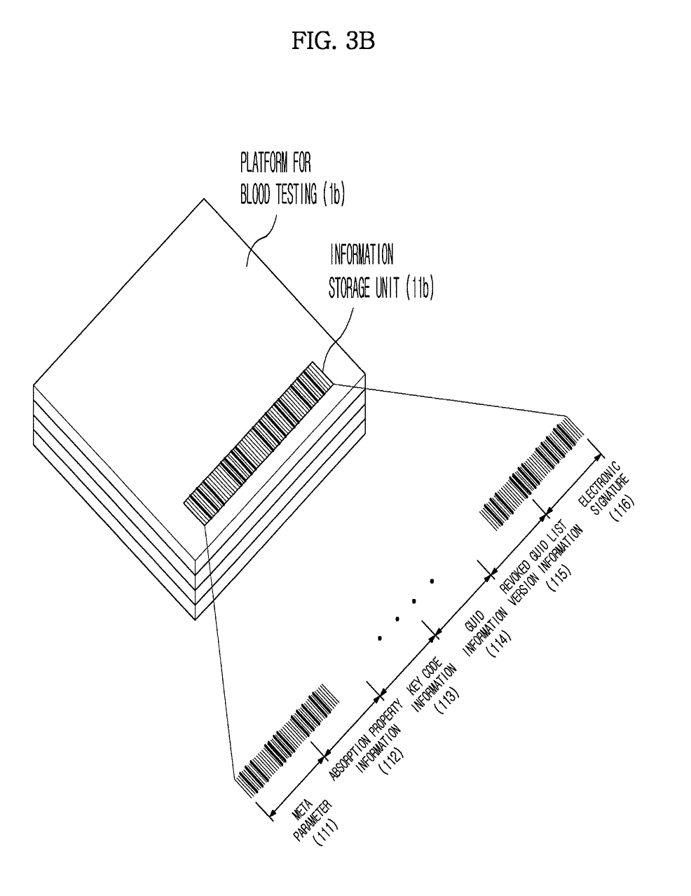

FIG. 3A is a view illustrating an information storage unit 11 of a platform 1 for blood testing according to an exemplary embodiment. The information storage unit 11 includes a meta parameter 111 region, an absorption property information 112 region, a key code information 113 region, a global unique identifier (GUID) information 114 region, a revoked GUID list version information 115 region, and an electronic signature 116 region.

FIG. 3B is a view illustrating an information storage unit 11b of a platform 1b for blood testing according to another exemplary embodiment. As previously described, the platform 1b may be configured in various forms according to use environments, and the information storage unit 11b may be attached to various parts of the platform 1b. Referring to FIG. 3B, the information storage unit 11b is attached to or printed on the upper surface of the platform 11b, which is tetragonal. The information storage unit 11b may include a meta parameter 111 region, an absorption property information 112 region, a key code information 113 region, a GUID information 114 region, a revoked GUID list version information 115 region, and an electronic signature 116 region, as shown in FIG. 3A. It will be appreciated by those skilled in the art that information stored in the information storage unit 11 may include only some pieces of the above information or other information having similar functions.

Referring back to FIG. 3A, the information storage unit 11 stores information related to the platform 1 and copy prevention information. A bar code, a combination of letters or numbers and black and white bar symbols, which is automatically read by a scientific mark reading apparatus, and a radio frequency identification (RFID) tag, which manages information using an IC chip and radio frequency, may be used to store information. Also, a combination of symbols by agreement between the platform 1 and the platform test apparatus 2 may be recorded and stored in the information storage unit 11 as information. Hereinafter, it is assumed that information of the information storage unit 11 is recorded on paper in the form of a bar code and is attached to the side of the platform 1 for the convenience of description.

When information is stored in the information storage unit 11 in the form of a bar code, regions of the information storage unit 11, i.e., the meta parameter 111 region, the absorption property information 112 region, the key code information 113 region, the GUID information 114 region, the revoked GUID list version information 115 region, and the electronic signature 116 region, may be determined according to agreement between the platform 1 and the platform test apparatus 2. That is, when the information storage unit 11 is attached to the side of the platform, as shown in FIG. 3A, information is recorded to a region determined according to agreement between the platform 1 and the platform test apparatus 2 in the form of a bar code during the manufacture of the platform 1. Also, an identification code may be provided before the region for the convenience of identification.

Information related to uses of the platform 1 is stored in the meta parameter 111 region. That is, information as to what the platform 1 is provided to test for, for example, whether the platform 1 is provided to test blood cholesterol values or blood sugar level, as previously described, is stored in the meta parameter 111 region. Although information to perform a general function (for example, a cholesterol test) according to uses of the platform 1 is stored in the meta parameter 111 region, a method of confirming the validity of the electronic signature 116 using a meta parameter 111 may be used in a method of preventing copy of the platform.

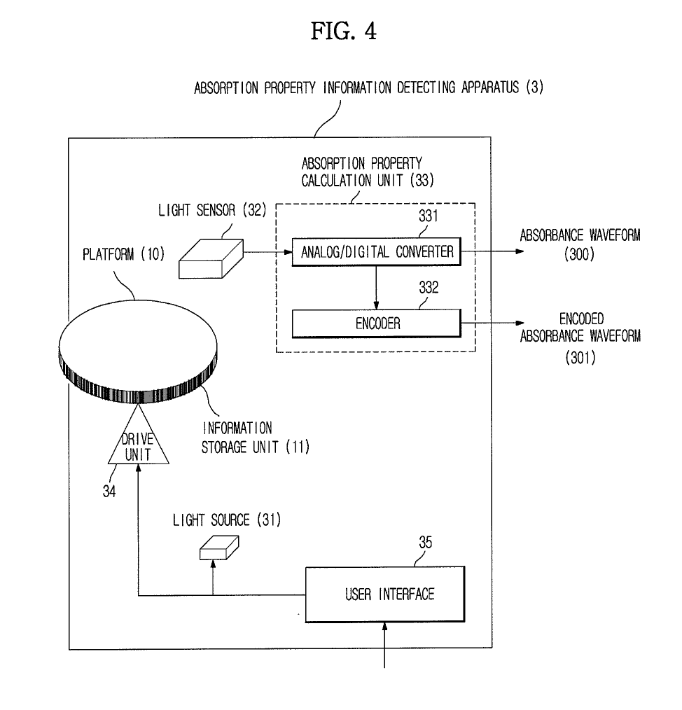

Information related to a property of the platform 1 absorbing light is stored in the absorption property information 112 region. Absorption is a phenomenon in which certain wavelengths of light are absorbed by an object while passing through the object. As previously described, the platform is constructed such that plates exhibiting optical transparency are stacked by bonding or fusing. When light is transmitted through a predetermined part of the platform while the platform performs rotational motion or translational motion, therefore, the platform has different absorption properties according to bonded forms between the stacked plates. Generally, light is vertically transmitted through the platform. However, it will be appreciated by those skilled in the art that the transmission of light is not limited thereto. FIG. 4 is a view illustrating a system for detecting absorption property information. Referring to FIG. 4, the system includes a platform 10 and an absorption property information detecting apparatus 3.

The absorption property information detecting apparatus 3 includes a light source 31, a light sensor 32, an absorption property calculation unit 33, a drive unit 34, and a user interface 35. The absorption property information detecting apparatus 3 detects an absorption property inherent to the platform 10. More specifically, when the absorption property information detecting apparatus 3 is operated through the user interface 35, the drive unit 34 rotates or translates the platform 10. When a platform 1 for blood testing, which is an exemplary embodiment of the platform 10, is used, the drive unit 34 generally rotates the platform 1. However, it will be appreciated by those skilled in the art that the platform 10 may be driven to have various kinds of motion in addition to the rotation. When light is emitted from the light source 31 and transmitted through a predetermined part of the platform 10 while the platform 10 is driven, the light sensor 32 senses the light transmitted through the predetermined part of the platform 10. An output of the light sensor 32 is input to the absorption property calculation unit 33, where an absorbance waveform 300 and/or an encoded absorbance waveform 301 of the light is calculated. Information on the absorbance waveform 300 and/or the encoded absorbance waveform 301 of the light is recorded in the absorption property information 112 region of the information storage unit 11.

The system for detecting absorption property information is generally used during the manufacture of the platform 10. However, the absorption property information 112 may be recorded in the information storage unit 11 using the system for detecting absorption property information after the manufacture of the platform 10 according to use environments.

In this exemplary embodiment, it is assumed that a light emitting diode (LED) is used as the light source 31. The LED is a semiconductor device that emits light when voltage is applied in the forward direction. In this exemplary embodiment, the LED is used as the light source 31 emitting light to detect absorption property information. However, it will be appreciated by those skilled in the art that other light sources having a function similar to the LED may be used. According to use environments, a gas lamp, a glow lamp, or a halogen lamp may be used in place of the LED.

The light sensor 32 senses light transmitted through a predetermined part of the platform 10 after the light is emitted from the light source 31. More specifically, when light is transmitted through a predetermined part of the platform constructed in a multi-layered structure, the platform has different properties of absorbance according to fused forms between the layers. Consequently, the light sensor 32 senses light transmitted through the predetermined part of the platform 10 to calculate an absorbance waveform of the platform 10.

The absorption property calculation unit 33 includes an analog/digital converter 331 and an encoder 332. The analog/digital converter 331 converts brightness of light acquired by the light sensor 32 into a digital value. That is, the analog/digital converter 331 converts an analog signal indicating a brightness of light acquired by the light sensor 32 into a digital value to calculate an absorbance waveform 300 of the platform 10. The absorbance waveform 300, which is a graph obtained by calculating brightness of light transmitted (a graph obtained by calculating intensity of light at different wavelengths transmitted) through the platform 10, represents an absorption property of the platform 10. For intensified platform test, the encoder 332 encodes the absorbance waveform 300 using a predetermined cryptographic method and outputs an encoded absorbance waveform 301.

The drive unit 34 rotates or translates the platform 10. The drive unit 34 includes a spindle motor for rotational motion or a motor for translational motion. It will be appreciated by those skilled in the art that the platform 10 may be driven in an electric drive manner, a mechanical drive manner, an air drive manner, or a hydraulic drive manner.

The user interface 35 includes input and output parts to operate and manipulate the absorption property information detecting apparatus 3. For example, the user interface may include a keyboard, a touch screen, and/or a mouse as the input parts, and a liquid crystal display (LCD) and a speaker as the output parts.

The calculation of the absorbance waveform 300 will be described in more detail. A predetermined part of the platform 10 is located between the light source 31 and the light sensor 32. When the platform 10 is embodied by the platform 1 for blood testing, light is generally transmitted in the vicinity of the chambers 12 during the rotation of the platform 1 according to a general use (for example, a blood test or genetic test) of the platform 1. However, it will be appreciated by those skilled in the art that an absorption property unique to the platform may be detected although light is transmitted through any part of the platform 10 while the platform 10 is driven. When the light source 31 is embodied by an LED, a plurality of LEDs may be used according to use environments. When the LED emits light, the light passes through a predetermined part of the platform 10, and the light sensor 32 senses the transmitted light. An analog signal indicative of the brightness of the light sensed by the light sensor 32 is converted into a digital value by the analog/digital converter 331. As a result, an absorbance waveform 300 is calculated. A property of the calculated absorbance waveform 300 is recorded in the absorption property information 112 region of the information storage unit 11 in the form of a bar code. At this time, the system for detecting absorption property information may record the detected absorbance waveform 300 in the form of a bar code. Alternatively, the same function as the above may be performed by an external apparatus. Also, the absorption property information 112 may be recorded in different manners according to storage methods (for example, bar code or RFID tag) of the information storage unit 11. The absorbance waveform 300 may be recorded in various manners. For example, a brightness value at a predetermined time, or properties of an angular point and an inflection point may be recorded according to agreement between the platform 10 and the platform test apparatus 2.

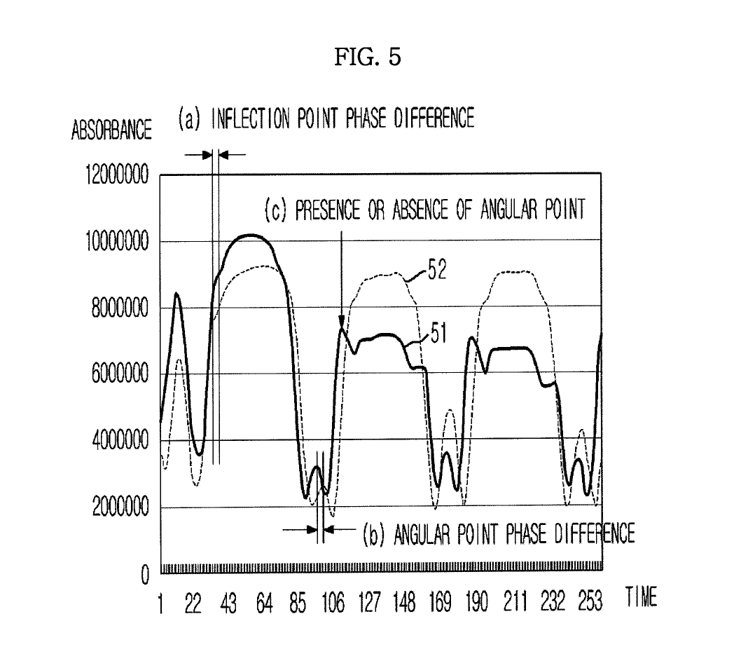

FIG. 5 is a view illustrating absorbance waveforms of platforms 1 for blood testing according to an exemplary embodiment. Referring to FIG. 5, there are shown absorbance waveforms 51 and 52 of two platforms 1 for blood testing. The two graphs 51 and 52 illustrate time-based absorbance values. Different absorbance waveforms indicate that two platforms 1 have different absorption degrees. More specifically, the two graphs 51 and 52 are different from each other in terms of an inflection point phase difference (a), an angular point phase difference (b), and presence or absence of an angular point (c). Consequently, illegal copy of the platform 1 is prevented using the absorption property information of the platform 1.

For stronger copy prevention, information of the encoded absorbance waveform 301 may be stored in the absorption property information 112 region. Referring back to FIG. 4, the encoder 332 encodes the absorbance waveform 300 calculated by the analog/digital converter 331, according to a hash algorithm to output an encoded absorbance waveform 301. The hash algorithm is a calculation method to create a pseudo-random number of a fixed length from a given original text. The created pseudo-random number is referred to as a hash value or a digest.

The encoding process will be described in more detail. The absorbance waveform 300 generated by the analog/digital converter 331 passes through a differentiator one or more times to calculate a singular point of the absorbance waveform 300. The singular point may include, for example, an inflection point, an angular point, an overlap point, and an isolation point of the waveform acquired by differentiating the absorbance waveform 300. After passing through the differentiator, the singular point of the absorbance waveform passes through a hash algorithm to output a digest, and the digest is encoded in symmetric key cryptography to calculate an encoded absorbance waveform 301. An encoding key used in the symmetric key cryptography is randomly created. The encoding key is stored in the key code information 113 region of the information storage unit 11. That is, as a result of encoding the absorbance waveform 300, the encoded absorbance waveform 301 is stored in the absorption property information 112 region of the information storage unit 11, and the encoding key used in the symmetric key cryptography is stored in the key code information 113 region of the information storage unit 11.

The symmetric key cryptography will be described in more detail. The symmetric key cryptography may be referred to as secret key cryptography. In the symmetric key cryptography, an encoding key used to encode the original text into a form that is difficult to understand is identical to a decoding key used to decode the encoded information into the original text. That is, one symmetric key is used as an encoding key and a decoding key. Consequently, the key code may be used as an encoding key and a decoding key to encode and decode the absorbance waveform 300.

The absorbance waveform 300 generated by the analog/digital converter 331 and/or the encoded absorbance waveform 301 generated by the encoder 332 is stored in the absorption property information 112 region. The platform test apparatus 2 analyzes the absorption property information 112 stored in the information storage unit 11 of the platform 10 to determine whether the platform is copied.

Referring back to FIG. 3A, information of a key code used during encoding of the absorbance waveform and/or during creation of the electronic signature is stored in the key code information 113 region. The key code is a combination of letters and numbers randomly created to be used as an encoding key during the manufacture of the platform 10. The key code and/or information acquired by encoding the key code is stored in the key code information 113 region.

An inherent identifier of the platform 10, i.e., GUID information, is stored in the GUID information 114 region. The GUID is an identifier created to distinguish between platforms 10 during the manufacture of the platforms 10. The GUID may be a combination of letters, numbers, and symbols. For example, factory lot information is combined to provide each platform 10 with a GUID unique thereto, and the GUID information is recorded in the GUID information 114 region of the platform 10.

More specifically, the platform 10 is disposable such that when a test is performed, the platform 10 is intended to be destroyed. That is, the platform 10 is not reusable. To this end, the platform test apparatus 2 stores the GUID information of the tested platform 10 to create a destroyed GUID list, and the GUID information of the platform 10 is compared with the destroyed GUID list, whenever the test is performed, to determine whether the platform 10 is copied or reused. Since a plurality of platform test apparatuses 2 are provided, a plurality of destroyed GUID lists may exist. The destroyed GUID list including the GUID information articles of the destroyed platform 10 may be shared by the platform test apparatuses 2 or through a server to manage and distribute the destroyed GUID list.

A revoked GUID list version at the time of manufacturing the platform 10 is stored in the revoked GUID list version information 115 region. Platforms 10 having GUIDs or GUID groups to be revoked due to manufacturing defects or illegal hacking may be sold and distributed although such GUID information has been exposed or reported. The revoked GUID list is a list of such GUID information to prohibit the use of the sold and distributed platforms 10. The revoked GUID list may be updated whenever new information is added. Consequently, a server to manage the revoked GUID list manages and periodically distributes the revoked GUID list, and also distributes version information indicating update information whenever the revoked GUID list is updated. Since test results performed by a platform 10 to be revoked are not reliable, the revoked GUID list to prevent the use of the platform 10 is systematically managed. Consequently, the revoked GUID list version information 115 is recorded in the platform 10 to systematically manage and test the revoked GUID list.

More specifically, the revoked GUID list stored in the server is periodically updated, the revoked GUID list stored in the platform test apparatus 2 is also updated. When the revoked GUID list of the platform test apparatus 2 is not updated although information of GUID groups to be revoked is added, problems of the corresponding GUIDs may be recognized. For this reason, the revoked GUID list is periodically updated. Consequently, the revoked GUID list at the time of manufacturing the platform 10 may be known by confirming the revoked GUID list version information 115. Subsequently, it is determined whether the revoked GUID of the platform test apparatus 2 is to be updated by confirming revoked GUID list version information when testing the platform 10. Consequently, an incorrect determination that the corresponding GUID is not GUID information of the defective platform 10 due to non-update of the revoked GUID list of the platform test apparatus 2 although the platform 10 belongs to a defective GUID group may be prevented. Related matters will hereinafter be described in more detail in connection with the platform test apparatus 2.

An electronic signature to confirm whether information stored in the information storage unit 11 of the platform 10 is valid is stored in the electronic signature 116 region. The electronic signature 116 is created by encoding a meta parameter 111, absorption property information 112, key code information 113, GUID information 114, and revoked GUID list version information 115 in predetermined cryptography. Creation of the electronic signature 116 will be described in more detail in connection with the platform test apparatus 2.

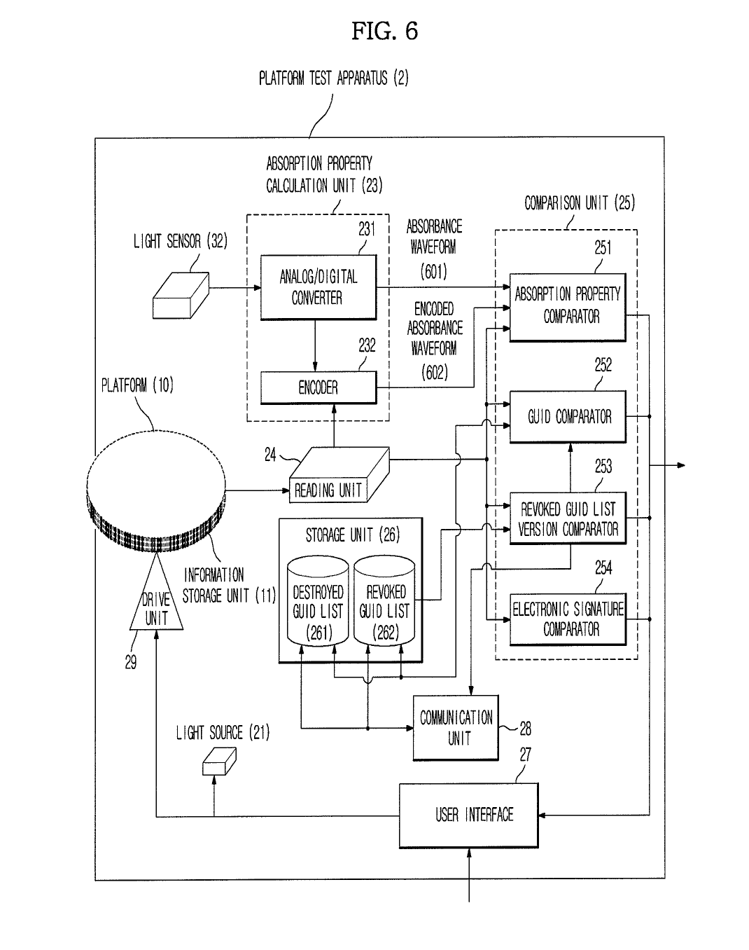

FIG. 6 is a detailed view illustrating the construction of a platform test apparatus 2 according to an exemplary embodiment shown in FIG. 1. It will be appreciated by those skilled in the art that the platform test apparatus 2 may be included in a normal tester, as previously described, or may be provided as a stand-alone apparatus only to determine whether the platform 10 is copied or defective. The platform test apparatus 2 includes a light source 21, a light sensor 22, an absorption property calculation unit 23, a reading unit 24, a comparison unit 25, a storage unit 26, a user interface 27, a communication unit 28, and a drive unit 29. The platform test apparatus 2 uses at least one selected from a group consisting of absorption property information, GUID information, revoked GUID list version information, and an electronic signature to test a platform 10.

The light source 21, the light sensor 22, and the absorption property calculation unit 23 perform the same process as the process of detecting the absorbance waveform 300 or the encoded absorbance waveform 301 in the system for detecting absorption property information described with reference to FIG. 4. When the platform test apparatus 2 is operated through the user interface 27, the drive unit 29 rotates or translates the platform 10. Light is emitted from the light source 21 passes through a predetermined part of the platform 10. The light sensor 22 senses the light transmitted through the platform 10, and an analog/digital converter 231 converts an anolog signal indicative of a brightness of the light acquired from the light sensor 22 into a digital value. The platform test apparatus 2 of FIG. 6 is identical to the system for detecting absorption property information of FIG. 4 in terms of a predetermined part of the platform 10 through which light emitted from the light source 21, 31 is transmitted and the manner in which the platform 10 is driven. That is, the part of the platform 10 through which light is transmitted to detect absorption property information and the manner in which the platform 10 is driven (for example, rotational motion) may be designated according to agreement between the system for detecting absorption property information and the platform test apparatus 2 during the manufacture of the platform 10. According to use environments, a part of the platform 10 through which light is transmitted may be marked.

The reading unit 24 reads a meta parameter 111, absorption property information 112, key code information 113, GUID information 114, revoked GUID list version information 115, or an electronic signature 116 from the information storage unit 11 of the platform 10. The reading unit 24 is set according to the form of information stored in the information storage unit 11. That is, when information is recorded in the information storage unit 11 in the form of a bar code, the reading unit 24 may be embodied by an optical detector to read the bar code. When information is recorded in the information storage unit 11 in the form of an RFID tag, the reading unit 24 may be embodied by an RFID reader. It will be appreciated by those skilled in the art that the optical detector or the RFID reader is merely an exemplary embodiment of the reading unit, and the reading unit 24 includes all kinds of devices to detect information based on agreement between the platform 10 and the platform test apparatus 2.

The comparison unit 25 compares information read from the information storage unit 11 of the platform 10 with information detected from the platform 10 to determine whether the platform 10 is copied or defective. The comparison unit 25 includes an absorption property comparator 251, a GUID comparator 252, a revoked GUID list version comparator 253, and an electronic signature comparator 254. The comparison unit 25 acquires absorption property information, GUID information, revoked GUID list version information, and electronic signature information from the absorption property calculation unit 23 and the storage unit 26, compares the acquired information with information read from the information storage unit 11 of the platform 10, and determines whether the platform 10 is copied or defective based on results of the comparison. According to results of determination, test results of the platform 10 may be reported through the user interface 27. In a structure in which the platform test apparatus 2 is attached to a normal tester, the test may be stopped when the platform 10 is copied or defective, and the test results may not be output.

The absorption property comparator 251 compares an absorbance waveform 600 acquired from the absorption property calculation unit 23 and/or an encoded absorbance waveform 601 with the absorption property information 112 of the information storage unit 11 read from the reading unit 24. Copy determination using the absorption property information 112 will be described in more detail. When the platform 10 is driven by the drive unit 29, light is emitted from the light source 21, the light is transmitted through a predetermined part of the platform 10, and the transmitted light is sensed by the light sensor 22. The light source 21 has the same construction as the light source 31 used during the manufacture of the platform 10, i.e., the light source 31 used in the absorption property information detecting apparatus 3 described with reference to FIG. 4. Also, predetermined sections of the platform 10 through which light is transmitted and motion of the platform 10 by the drive unit 29 and 34 are the same. The analog/digital converter 231 converts an analog signal indicative of a brightness of light acquired by the light sensor 22 into a digital value. As a result, an absorbance waveform 600 is calculated. The absorption property comparator 251 compares the property of the absorbance waveform 600 with the absorption property information 112 read by the reading unit 24. That is, the reading unit 24 reads absorption property information 112 from the information storage unit 11, the absorption property comparator 251 compares the property of the absorbance waveform 600 acquired from the analog/digital converter 231 with the absorption property information 112 acquired from the reading unit 24. When the two pieces of information coincide with each other, it is determined that the platform 10 is not copied. When the two pieces of information do not coincide with each other, it is determined that the platform 10 is copied. The determination results may be reported to a user through the user interface 27 or may stop the normal test by the platform 10. At this time, coincidence between the two pieces of information, i.e., the identity, may be designated according to user setting (for example, identity corresponding to accuracy of 100% or coincidence corresponding to accuracy of 90% of more).

For stronger copy prevention, when the encoded absorbance waveform 601 is stored as the absorption property information 112, the absorbance waveform 600 acquired from the analog/digital converter 231 is encoded using the same method as is performed by the system for detecting absorption property information during the manufacture of the platform 10. That is, the encoder 232 calculates a singular point from the absorbance waveform passing through a differentiator and outputs a digest from the calculated singular point passing through a hash algorithm. The reading unit 24 reads key code information 113 stored in the information storage unit 11 and encodes the output digest in symmetric key cryptography using the key code read from the key code information 113 as an encoding key. The digest and the key code information 113 are the same as the information used during the manufacture of the platform 10, i.e., the information used in the system for detecting absorption property information, the same encoded absorbance waveform 601 is calculated by the platform test apparatus 2.

The absorption property comparator 251 compares the encoded absorbance waveform 601 with the absorption property information 112 read from the information storage unit 11 by the reading unit 24. When the two pieces of information are the same, it is reported through the user interface 27 that the platform 10 is not copied, or the normal test is continued. On the other hand, when the absorbance waveform 601 encoded by the encoder 232 of the platform test apparatus 2 is not identical to the absorption property information 112 read by the reading unit 24, it is reported through the user interface 27 that the platform 10 is copied, or a test using the platform 10 is stopped.

Information as to whether information recorded in the absorption property information 112 region of the information storage unit 11 is the absorbance waveform 600 or the encoded absorbance waveform 601 may be stored in the meta parameter 111 or may be recorded in the form of a file when the absorption property information 112 is stored. As a result, the two pieces of information are distinguished from each other. The platform test apparatus 2 may acquire the above information through the reading unit 24 reading meta parameter 111 or absorption property information 112.

When it is assumed that the platform is embodied by the platform 1 for blood testing, absorbance analysis is performed during blood testing, and therefore, it is determined that the platform is copied without provision of an additional device to the blood tester. Also, when the platform 10 is copied, the information storage unit 11, i.e., the bar code information, is also copied. Consequently, when the copied bar code is attached to the copied platform, the absorption property information of the copied platform is different from the absorption property information of the original platform 10, with the result that the copied platform is identified. When copy determination is performed according to the above method and it is determined that the platform is copied, the test is stopped, and therefore, test reliability is improved. Also, the use of the copied platform is prevented, and therefore, sale of platforms, which are consumables, is promoted.

The GUID comparator 252 compares a GUID from a destroyed GUID list 261 and/or a revoked GUID list 262 with a GUID read from the GUID information 114 region of the platform 10 by the reading unit 24. The GUID information 114 is the only code of the platform 10 acquired by combining information (for example, factory lot information) related to the platform 10. The GUID information 114 is set at the time of manufacturing the platform 10. That is, a unique GUID is provided for each platform 10 and is recorded in the GUID information 114 region of the information storage unit 11 at the time of manufacturing the platform 10.

The destroyed GUID list 261 is stored in the storage unit 26 of the platform test apparatus 2 and/or an external storage medium. As previously described, the platform 10 is disposable, and therefore, when a test is performed, the platform 10 is destroyed. Consequently, when the platform 10 performs a test, the reading unit 24 reads the GUID information 114 of the platform 10, the read GUID is stored in a destroyed GUID list 261 of the storage unit 26 of the platform test apparatus 2 and/or an additional storage space to store the destroyed GUID list 261. The additional storage space may be connected to a platform test apparatus 2 or a plurality of platform test apparatuses 2 by a network to share a destroyed GUID list acquired by performing tests. In this exemplary embodiment, the network may be generally embodied by the Internet. However, it will be appreciated by those skilled in the art that the network may be embodied by a wireless local area network (LAN) or the like. Also, the platform test apparatuses 2 may be connected to each other by a network to share a destroyed GUID list acquired by performing tests. Hereinafter, it is assumed that the destroyed GUID list 261 is stored in the storage unit 26 of the platform test apparatus 2 for the convenience of description.

More specifically, the platform 10 is disposable, and therefore, after a test is performed, the platform 10 is not reusable. That is, the tested platform 10 is intended to be destroyed, and therefore, the corresponding GUID assigned to the platform 10 is not reused. In consideration of this, the platform test apparatus 2 stores GUIDs of the respective platforms 10 in the destroyed GUID list 261 whenever platforms 10 are tested. The stored destroyed GUID list 261 is a GUID list of the platforms 10 which have been tested and destroyed.

Whenever the platform test apparatus 2 tests the platform 10, the reading unit 24 reads the GUID information 114 of the information storage unit 11, and the GUID comparator 252 compares the read GUID information 114 with the destroyed GUID list 261 stored in the storage unit 26. When it is determined as a result of the comparison that the GUID read from the GUID information 114 is present in the destroyed GUID list 261, which indicates that the GUID corresponds to a destroyed platform 10, that the platform 10 is copied is reported through the user interface 27, and the test is stopped. On the other hand, when the GUID read from the GUID information 114 is absent in the destroyed GUID list 261, which indicates that the GUID is the one of the destroyed platform 10, that the platform 10 is not copied is reported through the user interface 27, or the normal test is continued.

In consideration of the fact that the platform 10 is a consumable, GUID information is created, the GUID is stored in the information storage unit 11 of the platform 10, and the GUID information 114 of the platform 10 is added to the destroyed GUID list 261 whenever the test is performed. Since the GUID of the copied platform 10 is identical to that of the original platform 10, the GUID information 114 may be compared with the destroyed GUID list 261 to determine whether the platform 10 is copied. Also, one platform 10 is generally copied, and therefore, when a plurality of platforms 10 having the same GUID exist, copied platforms 10 may be easily detected by comparing with the GUID information 114.

The revoked GUID list 262 is stored in the storage unit 26 of the platform test apparatus 2 and/or an external storage medium. The revoked GUID list 262 is a list of GUIDs or GUID groups to be revoked due to manufacturing defects or illegal hacking. Hereinafter, it is assumed that the revoked GUID list 262 is stored in the storage unit 26 of the platform test apparatus 2 for the convenience of description.

More specifically, when GUIDs of defective or copied platforms 10 are known, the corresponding platforms 10 are revoked. When the defective or copied platforms 10 have already been sold, delivered, or assigned, considerable time and effect is taken to withdraw and revoke the platforms 10. Consequently, the central management server creates, manages, and distributes a GUID list of the platforms 10 to be revoked, and the platform test apparatus 2 stores the revoked GUID list 262 acquired from the server in the storage unit 26 and the external storage medium.

As previously described, whenever the platform test apparatus 2 tests the platform 10, the reading unit 24 reads the GUID information 114 of the information storage unit 11, and the GUID comparator 252 compares the read GUID information 114 with the revoked GUID list 262 stored in the storage unit 26. When it is determined as a result of the comparison that the GUID read from the GUID information 114 is present in the revoked GUID list 262, which indicates that the GUID belongs to a platform 10 that has been recalled, it is reported through the user interface 27 that the platform 10 is defective, and the test is stopped. On the other hand, when the GUID read from the GUID information 114 is absent in the revoked GUID list 262, it is reported through the user interface 27 that the platform 10 is free from defect, or the normal test is continued.

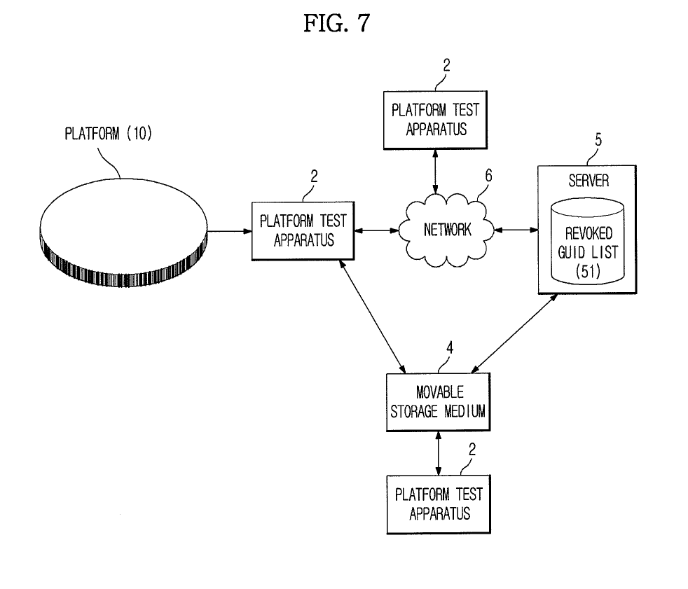

The revoked GUID list version comparator 253 compares the version of the revoked GUID list 262 stored in the storage unit 26 with the revoked GUID list version read from the revoked GUID list version information 115 region of the platform 10. As previously described, the revoked GUID list 262 in which information of GUIDs that have not been revoked is recorded is stored in the storage unit 26 of the platform test apparatus 2 and/or the external storage medium. Also, the revoked GUID list 262 is periodically updated by the server 5. To systematically manage such updated information, the revoked GUID list version information 115 includes information of a time when the revoked GUID list 262 was created. FIG. 7 is a view illustrating a platform test environment using the revoked GUID list version information 115.

Referring to FIG. 7, the platform test environment using the revoked GUID list version information 115 includes a platform 10, a platform test apparatus 2, a movable storage medium 4, a network 6, and a server 5. A plurality of platform test apparatuses 2 may be provided. As previously described, a revoked GUID list 51, which is information of GUIDs to be revoked due to manufacturing defects or illegal hacking, is managed and distributed by the server 5. The revoked GUID list 51 distributed from the server 5 is stored in the storage unit 26 of the platform test apparatus and/or an external storage space. Hereinafter, it is assumed that the revoked GUID list 51 distributed from the server 5 is stored in the storage unit 26 for the convenience of description. The platform test apparatus 2 and the server 5 are connected to each other through the network 6. The server 5 forcibly updates the revoked GUID list 262 of the platform test apparatus 2 periodically, when needed, or according to a result of the comparison with the revoked GUID list version information 115 based on user setting or default setting. In this exemplary embodiment, the network may be generally embodied by the Internet. However, it will be appreciated by those skilled in the art that the network may be embodied by a wireless LAN or the like. Also, not only is the revoked GUID list 51 updated by the server 5 through the network but also the revoked GUID list 262 is updated by the platform test apparatus 2 through the movable storage medium. In this exemplary embodiment, the movable storage medium is a recording medium which is movable and readable by a computer. The recording medium which is readable by the computer may be a magnetic storage medium (for example, a ROM, a floppy disk, a hard disk, etc.) or an optical reading medium (for example, a CD-ROM, a DVD, etc.). That is, the revoked GUID list 51 of the server 5 may be stored in the movable storage medium, and the platform test apparatus 2 may read the revoked GUID list 51 stored in the movable storage medium to update the revoked GUID list 262.

The server 5, connected to the platform test apparatuses 2 through the network, manages, issues, and distributes the revoked GUID list 51. Whenever GUID information to be revoked is created, the server updates the revoked GUID list 51. To systematically manage the revoked GUID list 51, the server 5 issues and distributes the revoked GUID list 51 including the updated information by version.

More specifically, a revoked GUID list version at the time of manufacturing the platform 10 is stored in the revoked GUID list version information 115. That is, a version (for example, version 1.1, etc.) of the revoked GUID list at the time of manufacturing the platform 10 is recorded in the revoked GUID list version information 115 of the information storage unit 11. The reading unit 24 of the platform test apparatus 2 reads the revoked GUID list version information 115, the revoked GUID list version comparator 253 compares the revoked GUID list version at the time of manufacturing the platform 10 read from the information storage unit 11 of the platform 10 by the reading unit 24 with the version of the revoked GUID list 262 stored in the platform test apparatus 2. When it is determined as a result of the comparison that the version of the platform test apparatus 2 is older than the version of the revoked GUID list version information 115 stored in the platform 10, the platform test apparatus 2 updates the revoked GUID list 262 through the communication unit 28. If the platform test apparatus 2 has the revoked GUID list 262, the version of which is older than the version of the revoked GUID list at the time of manufacturing the platform 10, the defective GUID may not be included in the revoked GUID list 262 of the platform test apparatus 2 although the corresponding GUID is included in the revoked GUID list 51 of the server 5. According to use environments, the test may not be performed unless the platform test apparatus 2 updates the revoked GUID list version from the server 5, thereby increasing the reliability of the platform test function.

When the revoked GUID list version information of the platform test apparatus 2 is identical to or newer than the revoked GUID list version information 115, the GUID comparator 252 compares the GUID information 114 of the platform with the revoked GUID list 262 stored in the storage unit 26, as previously described. According to a result of the comparison, whether the platform is copied or defective is reported to a user through the user interface 27, or the normal test using the platform 10 is stopped.

GUID information of many platforms 10 may be systematically managed using the revoked GUID list version information 115. Information of platforms having manufacturing defects or platforms illegally copied in large quantities may be systematically managed, thereby improving test reliability.

Referring back to FIG. 6, the electronic signature comparator 254 compares an electronic signature created by the platform test apparatus 2 with an electronic signature read from the electronic signature 116 region of the platform 10 by the reading unit 24. The electronic signature 116 is provided to prevent information stored in the information storage unit 11 from being illegally created. It is determined whether the electronic signature 116 is valid to confirm whether the information stored in the information storage unit 11 is valid, and it is determined whether the platform 10 is defective based thereon.

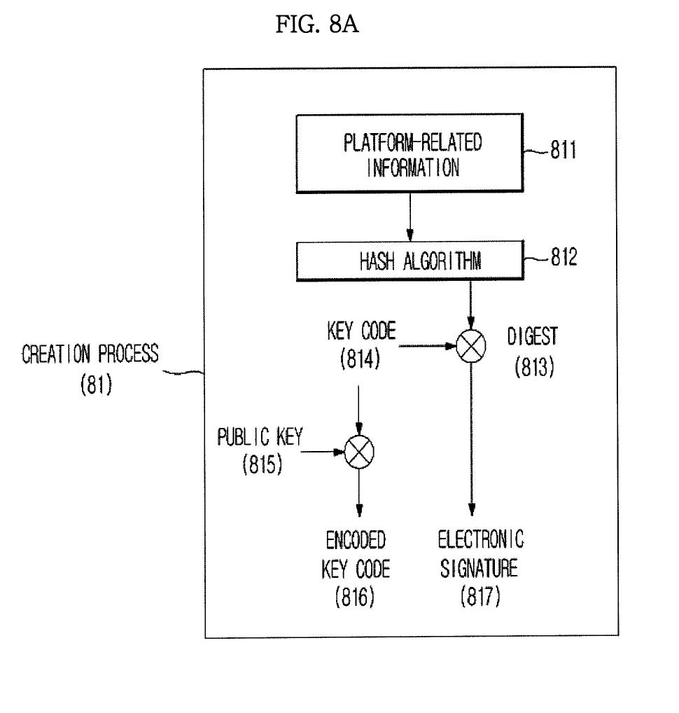

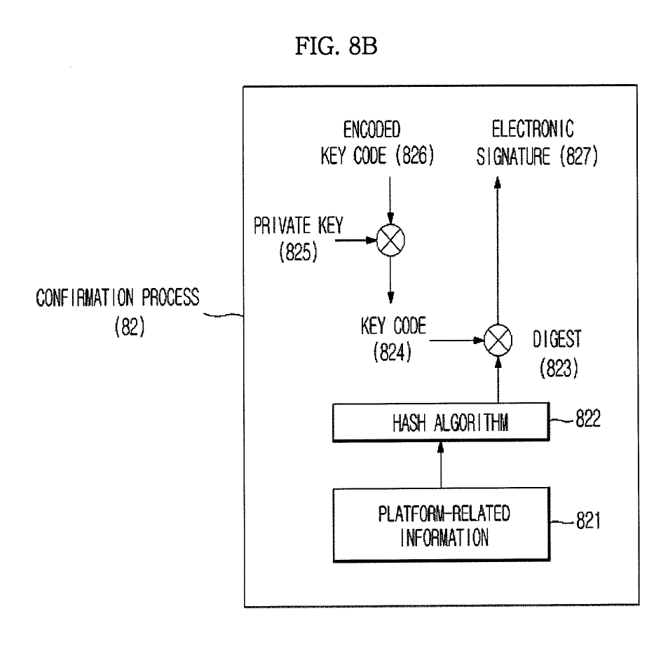

FIGS. 8A and 8B are views illustrating a method of creating an electronic signature 116 and a method of confirming an electronic signature 116, respectively, according to an exemplary embodiment. Referring to FIG. 8A, there is shown a creation process 81 of the electronic signature 116 which may be included in a process of manufacturing the platform 10 or may be performed before the platform 10 is sold, assigned, or delivered to a user after the platform 10 is manufactured. Referring to FIG. 8B, there is shown a confirmation process 82 of the electronic signature 116 which is performed by the electronic signature comparator 254 of the platform test apparatus 2 to test the platform 10.

The creation process 81 of the electronic signature 116 will be described in more detail. Platform-related information 811 passes through a hash algorithm 812 to create a digest 813, which is an output value. At this time, the platform-related information 811 includes at least one selected from a group consisting of a meta parameter 111, absorption property information 112, GUID information 114, and revoked GUID list version information 115, which have been previously described. The platform-related information 811 may use any combination of the above information items, which is determined by agreement between the platform 10 and the platform test apparatus 2. The created digest 813 is encoded in symmetric key cryptography using a key code 814 to create an electronic signature 817. The key code 814 is a combination of letters, numbers, and symbols randomly created to be used as an encoding key, as previously described with reference to FIG. 4. Also, the key code 814 is encoded in asymmetric key cryptography using a public key as an encoding key to create an encoded key code 816. As a result of creating the electronic signature 817, the encoded key code 816 and the electronic signature 817 are stored in the information storage unit 11 of the platform 10. The creation of the electronic signature 817 is performed at the time of manufacturing the platform 10. The created electronic signature 817 is recorded in the electronic signature 116 region of the information storage unit 11, and the encoded key code 816 is recorded in the key code information 113 region of the information storage unit 11.

The confirmation process 82 of the electronic signature 116 is performed by the platform test apparatus 2. The confirmation process 82 of the electronic signature 116 will be described in more detail. Platform-related information 821 passes through a hash algorithm 822 to create a digest 823, which is an output value, in the same manner as in the creation process 81 of the electronic signature 116. The platform-related information 821 is identical to the platform-related information 811 used in the creation process of the electronic signature 116. Also, the reading unit 24 reads the key code information 113 from the information storage unit 11 of the platform 10, an encoded key code 826 stored in the key code information 113 is decoded in asymmetric key cryptography using a private key 825 to restore a key code 824 before encoding. The key code 824 in the confirmation process of the electronic signature 116 is identical to the key code 814 in the creation process of the electronic signature 116. The created digest 823 is encoded in symmetric key cryptography using the key code 824 to create an electronic signature 827. The electronic signature comparator 254 compares the electronic signature 116 read by the reading unit 24 with the electronic signature 827 created in the confirmation process 82 of the electronic signature 116. When the electronic signatures are the same, that the electronic signature is valid and that the GUID of the platform 10 is valid or that the platform 10 is not copied is reported through the user interface 27, or the normal test is continued. When the electronic signatures 116 and 827 are not the same, that the platform 10 is copied or defective is reported through the user interface 27, or the normal test of the platform 10 is stopped.

Asymmetric key cryptography will be described in more detail. The asymmetric key cryptography is also referred to as public key cryptography. The asymmetric key cryptography performs encoding and decoding using an asymmetric key pair. The asymmetric key pair includes a public key and a private key. In the electronic signature creation process 81 of the platform 10, the public key 815 is used to encode the key code 814. The encoded key code 816 is decoded using the private key constituting the asymmetric key pair together with the public key. Consequently, the private key 825 constituting the asymmetric key pair together with the public key 815 used in the electronic signature creation process 81 is stored in the platform test apparatus 2. The platform test apparatus 2 detects meta parameter 111 information of the platform 10 and performs decoding using the private key 825 constituting the pair together with the platform 10.

It will be appreciated by those skilled in the art that the symmetric key cryptography or the asymmetric key cryptography is merely an exemplary embodiment of cryptography, and the creation process 81 and the confirmation process 82 of the electronic signature 116 may be performed using other kinds of cryptography having similar functions.

Illegal copy and distribution of GUIDs is prevented by adding the creating and confirmation processes of the electronic signature 116, thereby increasing the reliability of the platform 10 test method.

Referring back to FIG. 6, the user interface 27 displays whether the platform 10 is copied, and the platform test apparatus 2 is operated. The display includes visual information display (for example, a display device, an LCD screen, a graduation indicator, etc.) and auditory information provision (for example, a speaker).

The communication unit 28 transmits and receives the destroyed GUID list 261 and the revoked GUID list 262 to and from the server 5 and the other platform test apparatuses 2 through the network and/or the movable storage medium. When it is determined as a result of the comparison performed by the revoked GUID list version comparator 253 that the version of the revoked GUID list 262 of the storage unit 26 is older than the revoked GUID list version information 115 of the platform 10, the communication unit 28 updates the revoked GUID list 262 from the server 5 through the network and/or the movable storage medium. Also, the destroyed GUID list 261 may be shared by the other platform test apparatuses 2 through the communication unit 28. In this exemplary embodiment, the network may be generally embodied by the Internet. However, it will be appreciated by those skilled in the art that the network may be embodied by a wireless LAN or the like.

Also, the communication unit 28 may update the revoked GUID list 51 in the platform test apparatus 2 by the movable storage medium, as previously described. In this exemplary embodiment, the movable storage medium is a recording medium which is movable and readable by a computer. The recording medium which is readable by the computer may be a magnetic storage medium (for example, a ROM, a floppy disk, a hard disk, etc.) or an optical reading medium (for example, a CD-ROM, a DVD, etc.). That is, the revoked GUID list 51 of the server 5 may be stored in the movable storage medium, and the platform test apparatus 2 may read the revoked GUID list 51 stored in the movable storage medium to update the revoked GUID list 262.

The drive unit 29 rotates or translates the platform 10. The drive unit 29 includes a spindle motor for rotational motion or a motor for translational motion, as previously described with reference to FIG. 4. It will be appreciated by those skilled in the art that the platform 10 may be driven in an electric drive manner, a mechanical drive manner, an air drive manner, or a hydraulic drive manner.

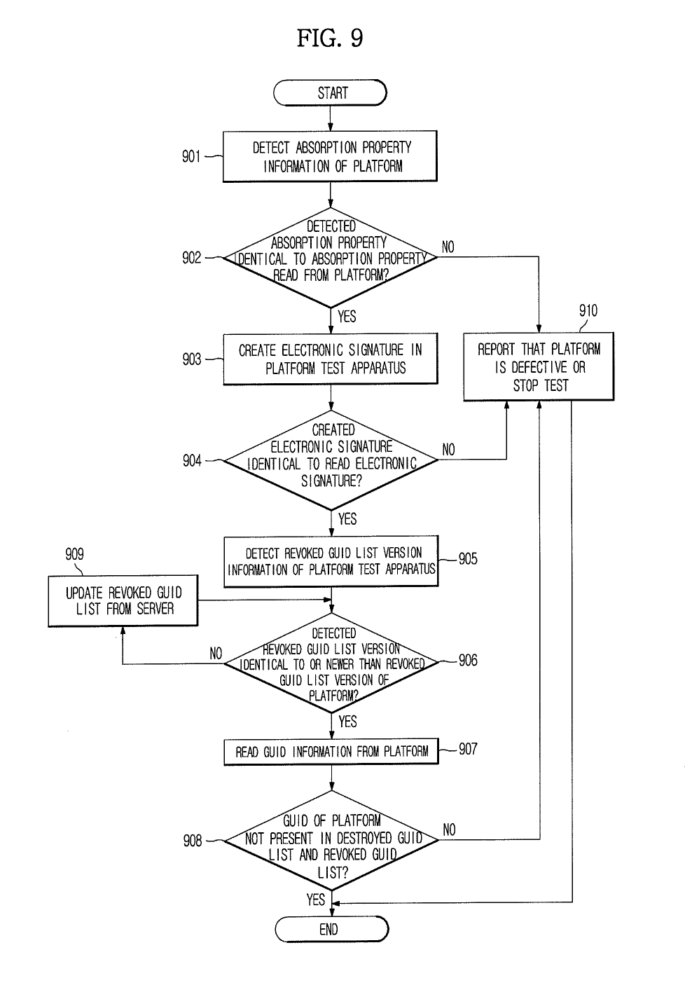

FIG. 9 is a flow chart illustrating a method of testing the platform 10 using the platform test apparatus 2. Referring to FIG. 9, the method of testing the platform 10 includes time-series operations in the platform 10 and the platform test apparatus 2 shown in FIG. 6. Although omitted, contents related to the platform 10 and the platform test apparatus 2 shown in FIG. 6 are also applied to the method of testing the platform 10 according to this exemplary embodiment.

In Operation 901, the platform test apparatus 2 detects absorption property information of the platform 10. The platform test apparatus 2 detects absorption property information of the platform 10 through the light source 21, the light sensor 22, the drive unit 29, and the absorption property calculation unit 23.

In Operation 902, the reading unit 24 of the platform test apparatus 2 reads absorption property information 112 stored in the information storage unit 11 of the platform 10, and the absorption property comparator 251 compares the read absorption property information with the absorption property information detected in Operation 901. When the two pieces of information are the same, the procedure advances to Operation 903. When the two pieces of information are not the same, the procedure advances to Operation 910 where it is reported through the user interface 27 that the platform 10 is copied or defective and/or the normal test of the platform 10 is stopped.

In Operation 903, the platform test apparatus 2 creates an electronic signature 116. That is, the platform test apparatus 2 creates an electronic signature 827 through the electronic signature creation process 81.

In Operation 904, the reading unit 24 of the platform test apparatus 2 reads the electronic signature 116 stored in the information storage unit 11 of the platform 10, and the electronic signature comparator 254 compares the electronic signature 827 created in Operation 903 with the read electronic signature 116. When the two electronic signatures are the same, the procedure advances to Operation 905. When the two electronic signatures are not the same, the procedure advances to Operation 910 where it is reported through the user interface 27 that the platform 10 is copied or defective and/or the normal test of the platform 10 is stopped.

In Operation 905, version information of a revoked GUID list 262 stored in the platform test apparatus 2 is detected. The revoked GUID list 262 is stored in the platform test apparatus 2 and/or an external storage space.

In Operation 906, the reading unit 24 of the platform test apparatus 2 reads revoked GUID list version information 115 of the information storage unit 11, and the revoked GUID list version comparator 253 compares the version information of the revoked GUID list, stored in the platform test apparatus 2, detected in Operation 905 with the revoked GUID list version information read by the reading unit 24. When the version information of the list stored in the platform test apparatus 2 is older than that of the platform 10, the procedure advances to Operation 909 where the revoked GUID list 262 is updated from the server 5. When the version information of the platform test apparatus 2 is identical to or newer than that of the platform 10, the procedure advances to Operation 907.

In Operation 907, the reading unit 24 of the platform test apparatus 2 reads GUID information 114 stored in the information storage unit 11 of the platform 10.

In Operation 908, the GUID comparator 252 of the platform test apparatus 2 compares the GUID information 114 read by the reading unit 24 with a revoked GUID list 262 and a destroyed GUID list 261 stored in the storage unit 26. When the same GUID is not present in the revoked GUID list 262 and the destroyed GUID list 261, which indicates that the platform 10 is free from defect, the normal test is continued. When the same GUID is present in the revoked GUID list 262 and the destroyed GUID list 261, the procedure advances to Operation 910 where it is reported through the user interface 27 that the platform 10 is copied or defective and/or the normal test of the platform 10 is stopped.

In Operation 909, the platform test apparatus 2 updates the revoked GUID list 262 from the server 5 through the network and/or the movable storage medium, and Operation 906 is performed.

In Operation 910, that the platform 10 is copied or defective is reported to the user through the user interface 27 and/or the normal test of the platform 10 is stopped.

The operations are performed to test the platform 10 using the platform test apparatus 2. As previously described, the operations may be selectively performed.

For example, when only a meta parameter 111, absorption property information 112, and an electronic signature 116 are stored in the platform 10, Operations 905 to 908 may be omitted.

A meta parameter 111, absorption property information 112, key code information 113, GUID information 114, revoked GUID list version information 115, and an electronic signature 116 are stored in the information storage unit 11 of the platform 10. The platform test apparatus 2 reads information from the information storage unit 11 and tests whether the platform 10 is copied or defective by direct measurement or acquisition from the platform 10 or by comparison with detected information. With this test method, whether the platform 10 is copied may be efficiently tested simply by adding software without addition of new hardware to existing equipment. Consequently, the platform 10 is prevented from being copied, thereby increasing platform profits, which are consumables, and improving test reliability.

As is apparent from the above description, a reliable platform is used, thereby improving test reliability. Also, platforms, which are consumables, are prevented from being copied, thereby increasing platform profits. Furthermore, platforms are prevented from being copied simply by adding software to the existing test process without additional devices.

Although a few exemplary embodiments have been shown and described, it will be appreciated by those skilled in the art that changes may be made in these exemplary embodiments without departing from the principles and spirit of the invention, the scope of which is defined in the claims and their equivalents.

What is claimed is:

1. A platform test apparatus comprising:
a drive unit which drives a platform to cause the platform to move in a predetermined manner;
at least one light source which emits light to the platform while the platform is driven so that the light is transmitted through a predetermined part of the platform;
a sensor which senses the light transmitted through the platform;
a calculation unit which calculates an absorption property of the platform based on a detected result output by the sensor;
a reading unit which reads absorption property information of the platform stored in an information storage unit of the platform; and
a comparison unit which compares the absorption property calculated by the calculation unit with the absorption property information read by the reading unit to determine whether the platform is copied.

2. The platform test apparatus according to claim 1, wherein the reading unit comprises at least one of an optical detector which reads bar code information and a reader which reads radio frequency identification tag information.

3. The platform test apparatus according to claim 1, wherein:
the reading unit reads revoked global unique identifier (GUID) list version information stored in the information storage unit of the platform, and
the comparison unit compares revoked GUID list version information stored in the platform test apparatus or an external storage medium with the revoked GUID list version information read from the information storage unit of the platform by the reading unit,
the platform test apparatus further comprising a communication unit which updates a revoked GUID list from an external apparatus using a network or a movable storage medium according to a result of the comparison by the comparison unit.

4. The platform test apparatus according to claim 3, wherein the communication unit forcibly updates the revoked GUID list from the external apparatus according to the result of the comparison by the comparison unit.

5. The platform test apparatus according to claim 1, wherein:
the reading unit reads global unique identifier (GUID) information stored in the information storage unit of the platform, and
the comparison unit compares a destroyed GUID list or a revoked GUID list stored in the platform test apparatus or an external storage medium with the GUID information read from information storage unit of the platform by the reading unit.

6. The platform test apparatus according to claim 1, wherein:
the reading unit reads an electronic signature and platform-related information stored in the information storage unit of the platform,
the comparison unit comprises an electronic signature comparator which encodes the platform-related information in predetermined cryptography to generate an electronic signature and compares the generated electronic signature with the electronic signature read by the reading unit to determine whether the platform is copied, and
the platform-related information comprises at least one selected from a group consisting of absorption property information of the platform, key code information, global unique identifier (GUID) information, and revoked GUID list version information.

7. A platform comprising:
a plurality of plates arranged in a multi-layered structure; and
an information storage unit which stores absorption property information of the plates based on light transmitted through the platform while the platform moves a predetermined manner.

8. The platform according to claim 7, wherein:
the information storage unit further stores key code information to encode the absorption property, and
the absorption property information is generated by encoding the absorption property of the platform in predetermined cryptography using the key code information as an encoding key.

9. The platform according to claim 7, wherein the information storage unit further stores at least one selected from a group consisting of key code information, global unique identifier (GUID) information, revoked GUID list version information, and an electronic signature.

10. The platform according to claim 7, wherein:
the key code information is generated by encoding a key code in predetermined cryptography, and
the key code is randomly generated to be used in the predetermined cryptography.

11. The platform according to claim 9, wherein:
the electronic signature is generated by encoding platform-related information in predetermined cryptography, and
the platform-related information comprises at least one selected from a group consisting of the absorption property information, the key code information, the GUID information, and the revoked GUID list version information.

12. The platform according to claim 7, wherein information is recorded in the information storage unit using a bar code or a radio frequency identification tag.

13. A method for testing a platform, the method comprising:
detecting absorption property information of the platform;
reading absorption property information of the platform recorded in an information storage unit of the platform; and
determining whether the platform is copied by comparing the detected information with the read information.

14. The method according to claim 13, wherein:
the reading the absorption property information comprises reading revoked global unique identifier (GUID) list version information stored in the information storage unit of the platform, and
the determining whether the platform is copied comprises:
comparing revoked GUID list version information stored in a platform test apparatus or an external storage medium with the revoked GUID list version information read from the platform,
updating a revoked GUID list according to a result of the comparing, and
comparing the revoked GUID list with GUID information stored in the information storage unit of the platform.

15. The method according to claim 14, wherein the determining whether the platform is copied further comprises forcibly updating the revoked GUID list according to the result of the comparing.

16. The method according to claim 14, wherein the determining whether the platform is copied further comprises updating the revoked GUID list from an external apparatus using a network or a movable storage medium.

17. The method according to claim 13, wherein:
the reading the absorption property information comprises reading global unique identifier (GUID) information stored in the information storage unit of the platform, and
the determining whether the platform is copied comprises comparing a destroyed GUID list or a revoked GUID list stored in stored in a platform test apparatus or an external storage medium with the GUID information read from the platform.

18. The method according to claim 13, wherein
the reading the absorption property information comprises reading an electronic signature and platform-related information stored in the information storage unit of the platform,
the determining whether the platform is copied comprises encoding the platform-related information in predetermined cryptography to generate an electronic signature and comparing the generated electronic signature with the read electronic signature, and
the platform-related information comprises at least one selected from a group consisting of absorption property information, key code information, global unique identifier (GUID) information, and revoked GUID list version information.

19. The method according to claim 13, wherein reading absorption property information comprises reading bar code information or radio frequency identification tag information of the platform.

20. A computer readable recording medium having recorded thereon a program that is executed by a computer to perform the method according to claim 13.
